(19) United States
(12) Patent Application Publication
(10) Pub. No.: US 2007/0000366 A1
(43) Pub. Date: Jan. 4, 2007

(54) Table saw guard assembly

(76) Inventors: David G. Peot, Easley, SC (US); William C. Buck, Clemson, SC (US)

Correspondence Address: BRINKS HOFER GILSON & LIONE, P.O. BOX 10395, CHICAGO, IL, 60610, US

(21) Appl. No.: 11/516,271

(22) Filed: Sep. 5, 2006

Related U.S. Application Data
(63) Continuation of application No. 10/601,721, filed on Jun. 23, 2003.

(51) Int. Cl. B23D 45/06

(52) U.S. Cl. 83/102.1; 83/477.2; 83/478

(57) ABSTRACT

An improved riving knife/guard assembly for a table saw allows the guard to be removed and attached without the use of any tools, provides a clear view of the work zone, blade and workpiece, and is easily adjustable to accommodate different size workpieces and cutting angle.

### BACKGROUND

Typical table saws include a base or frame having a flat table top or supporting a flat table top. The table top generally includes a slot through which a cutting member, such as a circular saw, protrudes above the table top. Often, a riving knife or splitter is mounted directly in line with the saw blade. The riving knife operates to keep separate the two sides of the portion of the workpiece that has been cut. By keeping the workpiece separated, it reduces the possibility of the workpiece binding as it is cut. Table saws also include a guard to protect the operator from potential serious injury caused by accidental contact with the saw blade. The guard is located in such a way so that it prevents the operator from contacting the saw blade while in use.

Many types of riving knives and guard assemblies have been used in the past. However, these assemblies have often been difficult to use because they are typically quite flimsy and obstruct the operator's view of the workpiece, or the saw blade, or the reference marks or scales used to align the workpiece. As a result, many guards are often removed which in turn results in a higher probability of accidents and injuries. Additionally, the removal of guards from the table saw often requires the use of tools making the adjustment or maintenance of the saw blade and riving knife complicated and difficult.

Accordingly, objects of the present invention include providing a table saw having a riving knife/guard assembly that: provides the operator with protection from the blade; provides a clear view of the cutting or work zone, the workpiece to be cut, the saw blade, and any scale or alignment marks; allows for easy removal and installation of the guard without the use of any tools; that can easily accommodate different size workpieces; and is sturdy.

### BRIEF SUMMARY

An improved riving knife/guard assembly is provided for use with a table saw. The assembly includes a riving knife that is mounted to the table saw frame in line with the saw blade. The riving knife is adjustable directly with the blade so that as the blade height is adjusted to accommodate for different size workpieces, or the blade angle is adjusted for bevel cuts, the riving knife is similarly adjusted.

A guard is attached to the riving knife. The guard is attached to the riving knife using a system of one or more pins that engage slots on the riving knife. The slots can be dogleg shaped and oriented in opposing directions. At least one of the pins is a multi-position pin that can be placed in at least two positions. In one position, the guard is securely and rigidly mounted to the riving knife. In a second position, the guard can be removed from the riving knife.

The guard also can be provided with a viewing slot that allows the operator to see the cutting zone, and/or the workpiece that is being cut, and/or the saw blade, and/or any scale or alignment marks. To further enhance viewing, the guard can be provided with a light or a magnifying lens or both.

The guard may also include a bail. The bail may be pivotally mounted onto the guard top plate. The pivot mounting allows the bail to be raised or lowered and to also be movable to accommodate different size workpieces. The bail may also be two-piece construction. This provides further flexibility for accommodating different size workpieces and bevel cuts.

### BRIEF DESCRIPTION OF THE DRAWINGS

The features and advantages of the present invention may be better understood by reference to the accompanying drawings in which like reference numerals refer to like elements and in which:

FIG. 1 is a perspective view of an exemplary table saw incorporating various features according to the present invention.

FIG. 2 is a side view of a riving knife/guard assembly and saw blade (removed from the table saw) incorporating various features according to the present invention.

FIG. 3 is a top view of a riving knife/guard assembly incorporating various features according to the present invention.

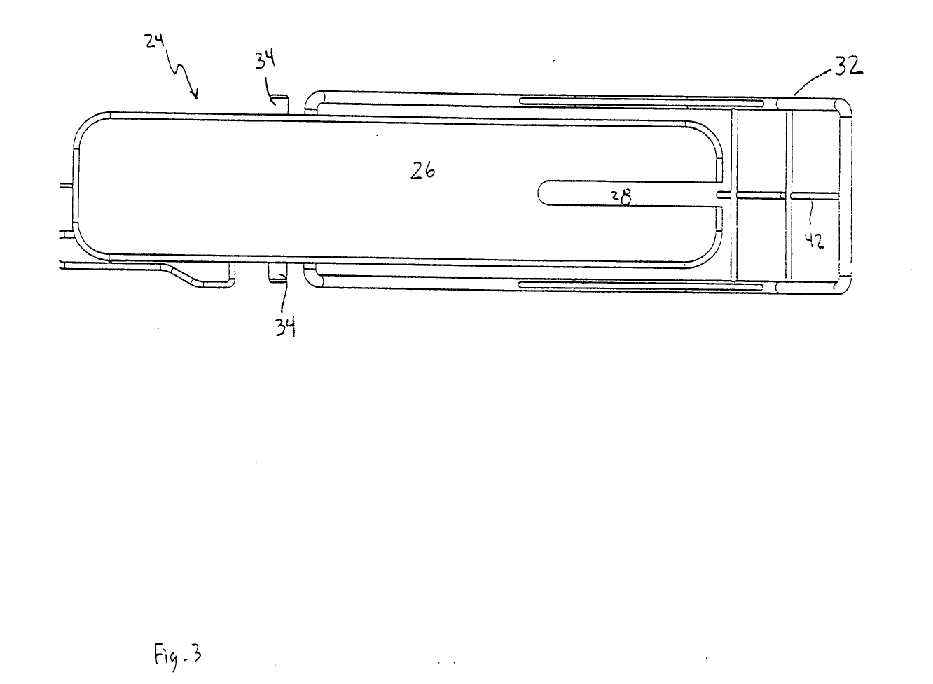

FIG. 4 is a perspective view of an exemplary table saw incorporating various features according to the present invention including a riving knife/guard assembly where the bail is in an up or lifted position.

FIG. 5 is an exploded view of a riving knife/guard assembly incorporating various features according to the present invention.

FIG. 6 is a front view of a portion of a table saw, including the saw blade, table top and riving knife/guard assembly incorporating various features according to the present invention.

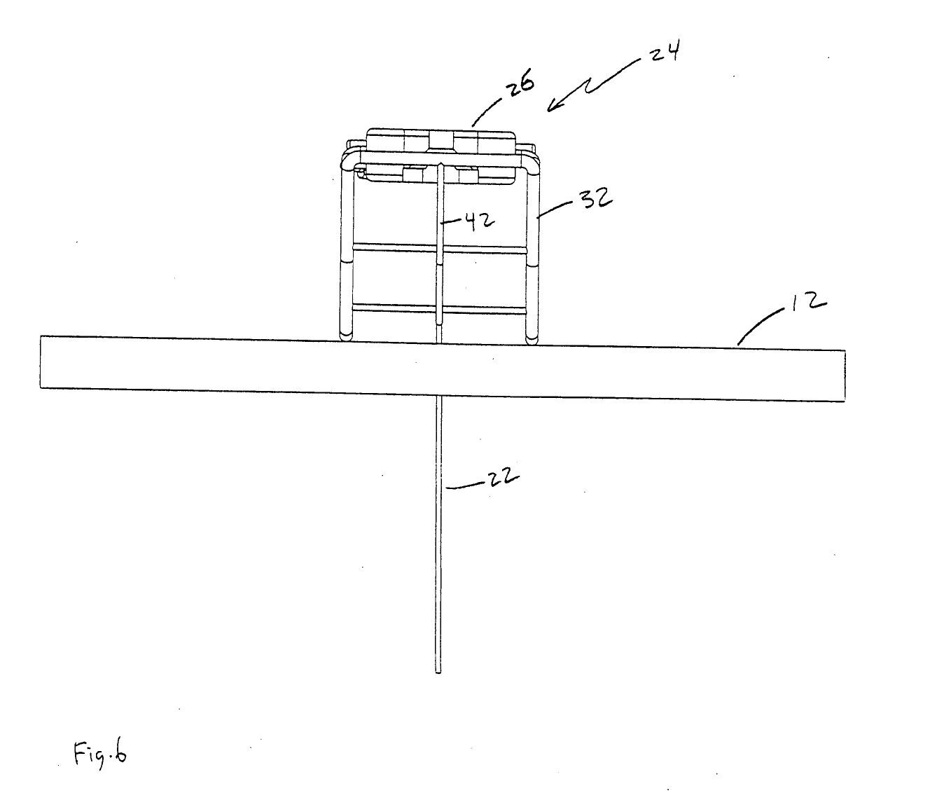

FIG. 7 is a bottom view of a riving knife/guard assembly incorporating various features according to the present invention.

FIG. 8 is a perspective view of a riving knife, multi-position pin and second pin incorporating various features according to the present invention.

FIG. 9 is a side view of a riving/knife guard assembly incorporating various features according to the present invention.

FIG. 10 is a front/top view of a guard top plate incorporating various features according to the present invention, including a light and a magnifying lens.

FIG. 11 is a front view of a guard top plate incorporating various features according to the present invention, including chamfered interior surfaces and a chamfered exterior surface.

FIG. 12 is a front view of a guard assembly incorporating various features according to the present invention, including a two piece bail.

### DETAILED DESCRIPTION OF THE DRAWINGS AND THE PRESENTLY PREFERRED EMBODIMENTS

While this invention is susceptible of several different embodiments, this specification and the accompanying drawings disclose only some specific forms as examples of the invention, including the most preferred embodiment. The invention is not intended to be limited by the descriptions in this specification or the drawings. Instead, the scope of the invention is provided in the claims.

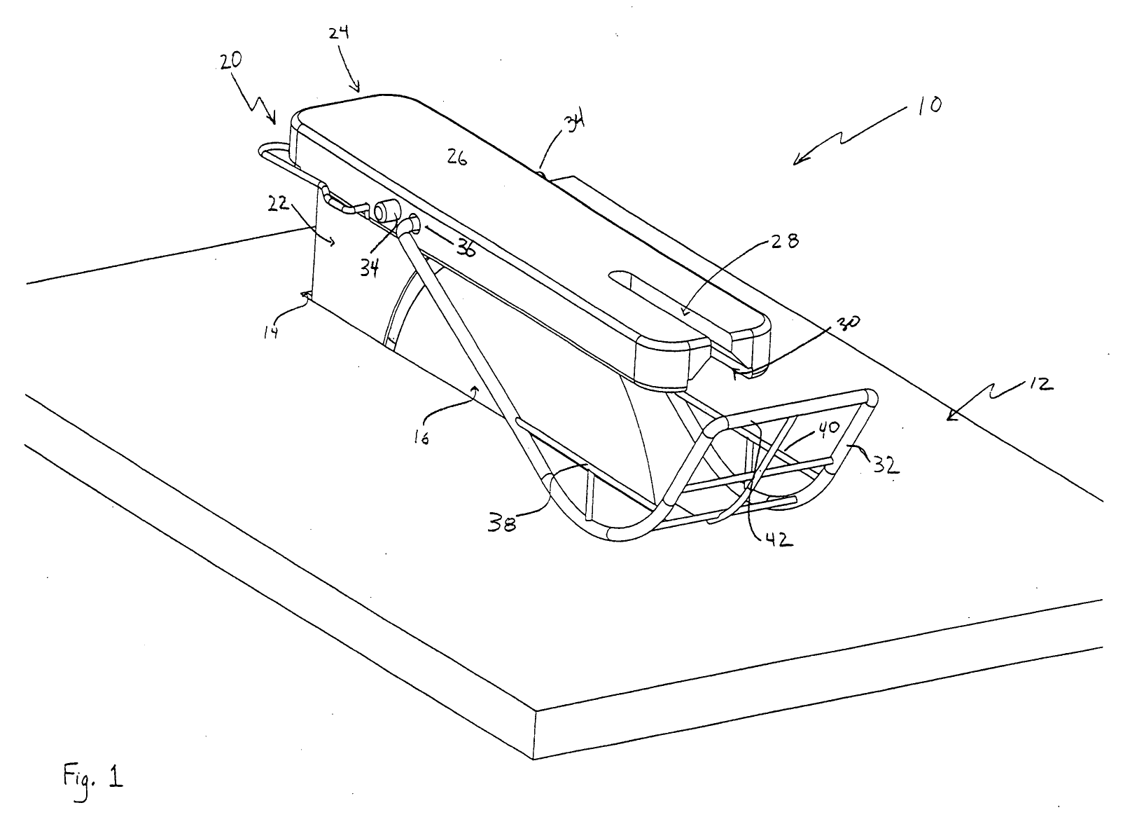

FIG. 1 shows a table saw (10) having the improved riving knife/guard assembly (20). The table saw includes a table top (12). The table top (12) includes a slot (14). A saw blade (16) is conventionally mounted to a motor and carriage (both not shown) that is located under the table top (12). The saw blade (16) protrudes through the slot (14). The portion of the blade (16) that protrudes through the slot (14) is the operative portion for cutting a workpiece (not shown).

A riving knife or splitter (22) is also mounted to the table saw. The riving knife (22) preferably is mounted to the carriage (not shown) under the table top (12) in such a manner so that it is centered behind or aligned with the saw blade (16). Since the carriage is the same as that on which the saw blade (16) is mounted, adjustment of the height or angle of the saw blade (16) will result in an identical adjustment in height or angle to the riving knife (22). Alternatively, the riving knife (22) can be fixedly mounted to a portion of the frame other than the carriage so that the riving knife (22) is not adjustable with the saw blade (16). The riving knife (22) operates to keep the cut portion of the workpiece split or separated after it is cut and as the remainder of the workpiece is fed through the saw blade (16). Splitting or keeping the cut portions of the workpiece separated helps to prevent potential binding of the saw blade (16) during operation. Optimally, the riving knife (22) is spaced approximately ⅛ inch from the saw blade (16) to reduce the possibility for binding and kickback. Additionally, it is preferred that the riving knife (22) be at a height slightly lower than the saw blade (16) height. This allows the riving knife (22) to be left in place for non-through cuts.

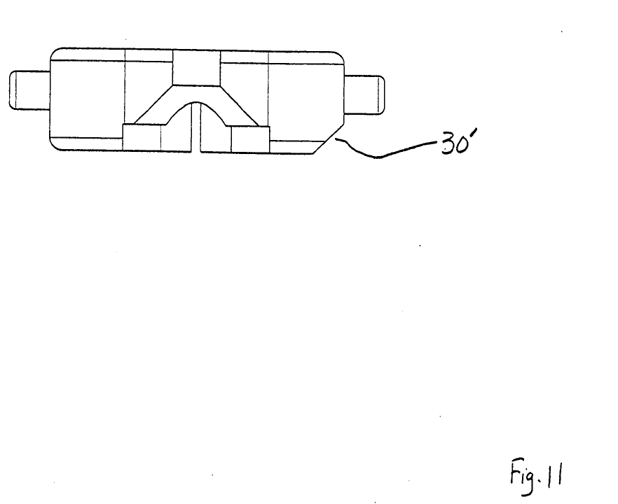

A guard (24), as explained in more detail below, is attached to the riving knife (22). The guard includes a housing or guard top plate (26). The guard top plate (26) comes down around the blade (16) to protect the operator from contacting the blade (16). Because the guard (24) is attached to the riving knife (22), the workpiece does not come into contact with the guard top plate (26). The guard top plate (26) preferably has a viewing slot (28) at its front end. The front end is the end where the workpiece is fed into the table saw (10). The viewing slot (28) provides the operator with increased visibility of the work zone or cutting zone as well as the workpiece being cut, the saw blade (16), and any alignment markings or scale (not shown) on the table top (12) in the work zone. The use of alignment markings and a scale are conventional in the table saw industry. The guard top plate (26) also has interior chamfered edges (30) at its front portion, i.e., the workpiece feed portion of the guard top plate (26). The chamfered edges (30) serve several purposes. The chamfered edges (30) increase the view of the cutting zone, as well as the blade (16) and workpiece, while maximizing the distance from the blade (16) to the operator. Further, they facilitate better light dispersion from an on board light (described below). As shown in FIG. 11, the outside edges (30′) of the guard top plate may also be chamfered. While FIG. 11 only illustrates one outside edge (30′) that is chamfered, both may be chamfered. The chamfered outside edge (30′) helps to maximize the range of useful height for beveled cuts without having to remove the guard (24).

Additionally, the blade (16) may be recessed in the guard (24). Thus, when the guard top plate (26) is placed just above the height of the workpiece to be cut, the blade (16) will automatically be at the correct height for the cut.

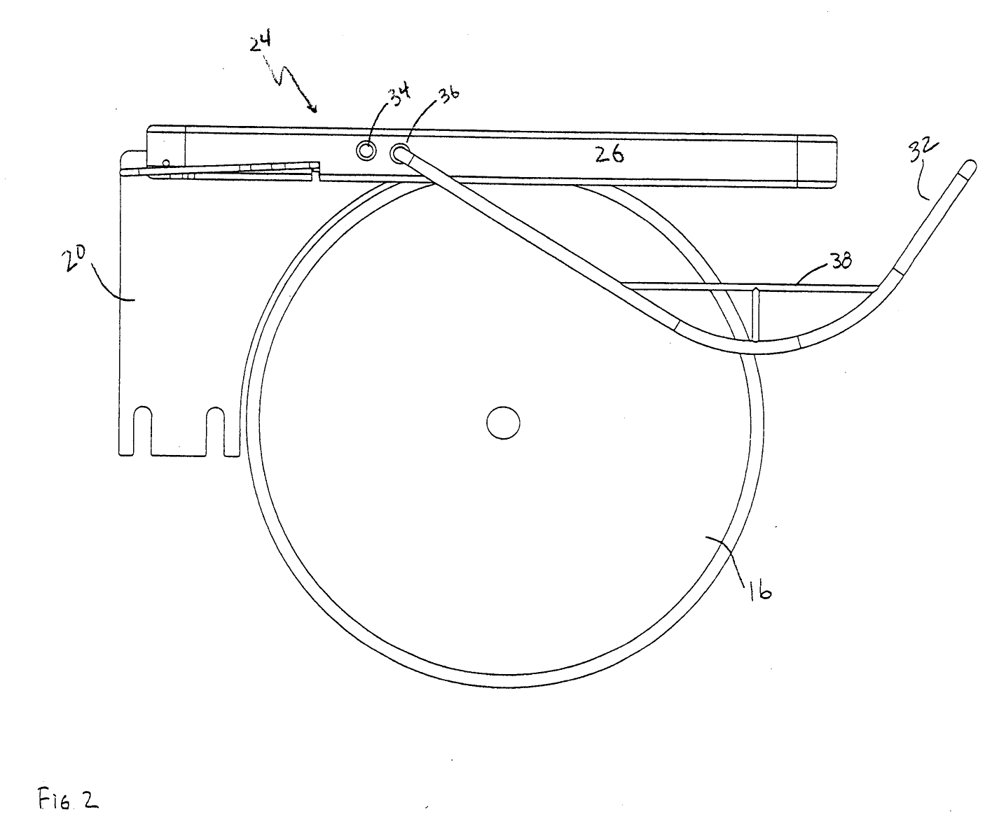

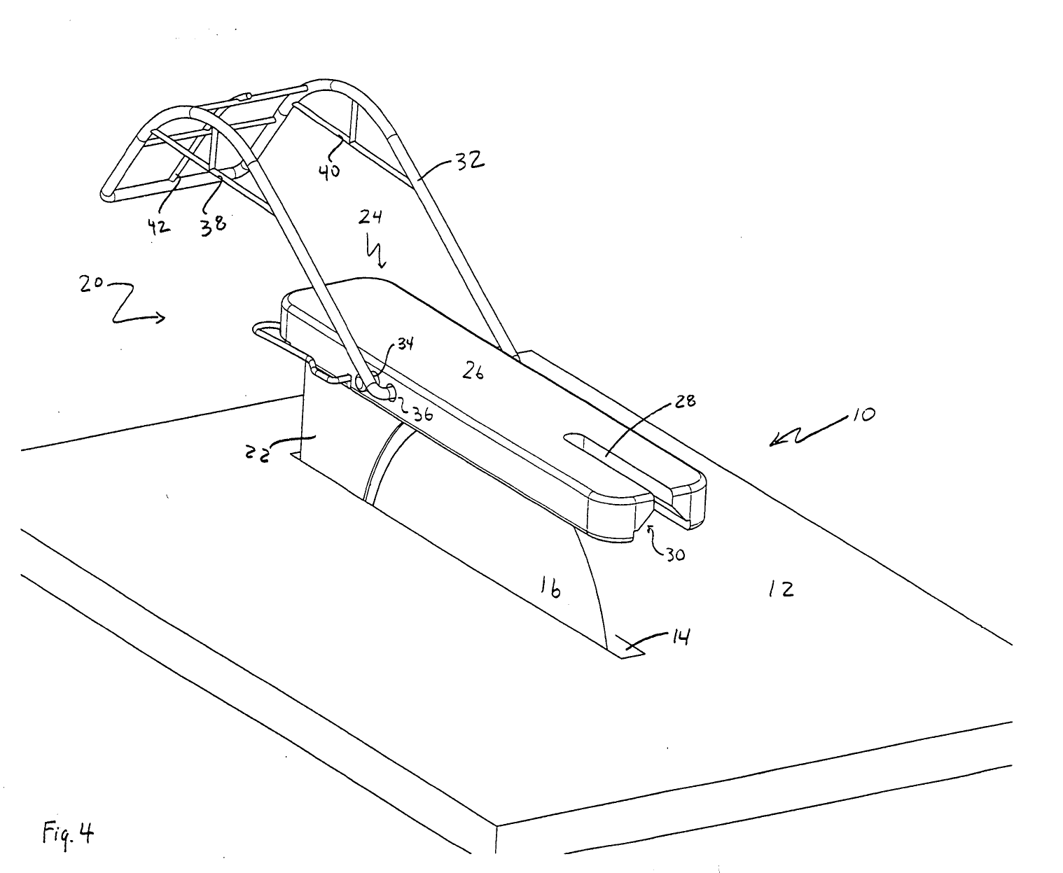

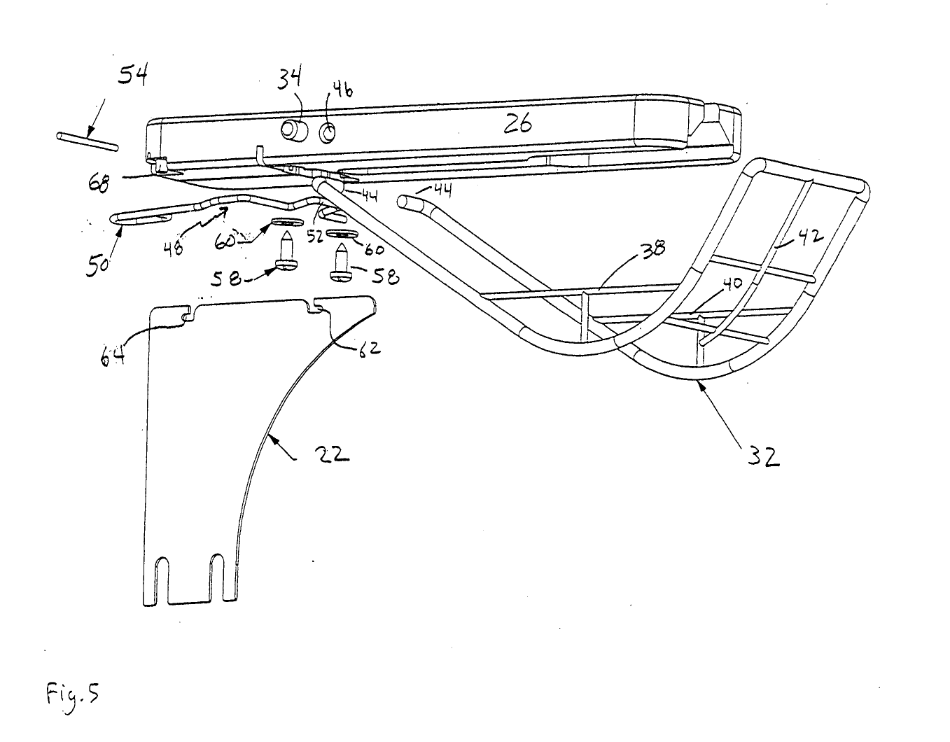

The guard (24) may also include a bail (32). The bail (32) is pivotally mounted (36) to the guard top plate (26). The bail is also shaped so that when the workpiece being cut is moved towards the blade (16), the bail (32) rides over the workpiece to allow the workpiece to move into the cutting zone. The combination of the bail's (32) shape along with the pivot mounting (36), allows for this to occur. The arc-shaped bail (32) shown in FIG. 1 will offer very little resistance when feeding the workpiece, and will also reduce the forces that tend to make the guard top plate (26) flex during use so that the guard top plate (26) does not hit the blade (16) or interfere with the cutting operation. As can best be seen in FIGS. 1, 2 and 5, the bail (32) has sides (38, 40) that extend beyond the sides of the guard top plate (26). The sides (38, 40) provide protection from the blade (16) both before and after the cut. Likewise, the bail (32) has a front portion (42) that will contact an operator's hands or fingers that are on top of the workpiece as it is fed to be cut, thus giving a warning that the operator's hands or fingers may be coming near the blade (16). The bail (32) is also designed not to interfere with measuring, aligning or setting up the workpiece due to its pivotal mounting (36). Specifically, as shown in FIG. 4, the bail (32) can be lifted and rotated back onto a pair of stops (34) located on either side of the guard top plate (26). The guard top plate (26) will remain in place even when the bail (32) is lifted into a raised or up position from its lowered or down position. As shown in FIG. 5, the bail (32) has stub ends (44) that fit into stub receiving orifices (46) (only one is shown) for pivotally mounting (36) the bail (32) to the guard top plate (26). The utilization of the stub ends (44) and stub receiving orifices (46) allows the bail (32) to be removed and attached to the guard top plate (26) without the use of any tools.

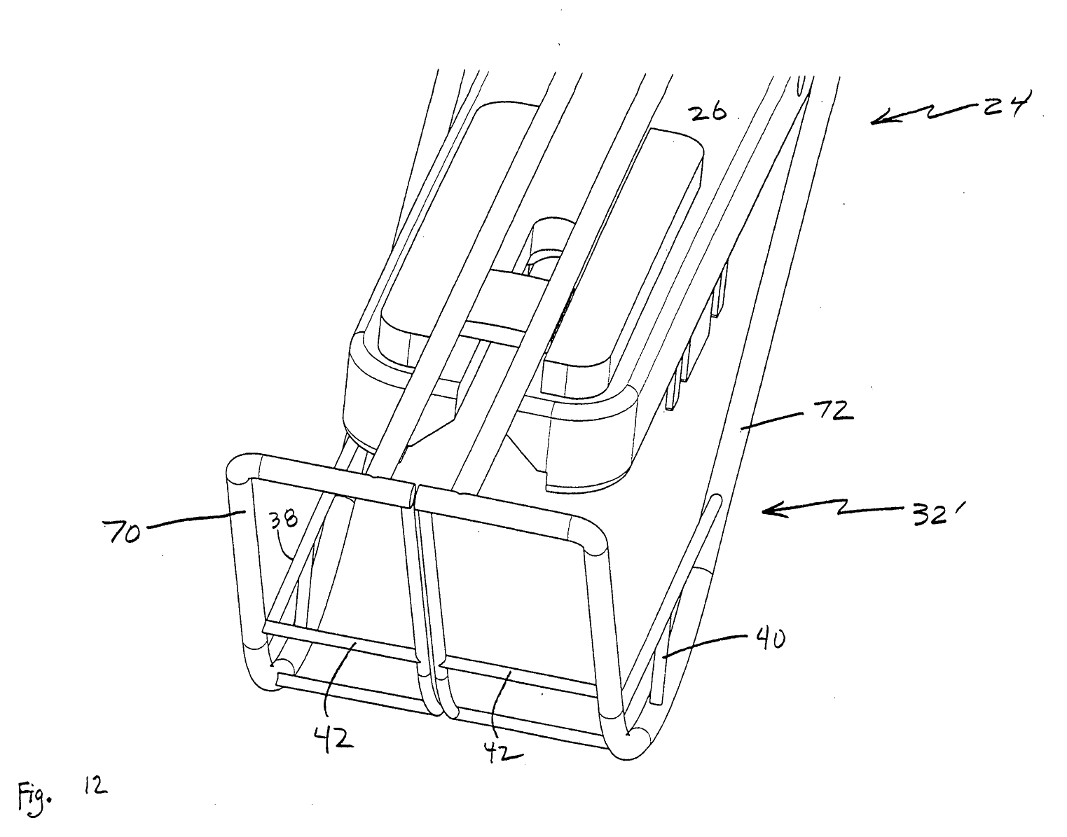

An alternate bail (32′) is shown in FIG. 12. The bail (32′) operates and functions similar to the bail (32) except that it is two distinct pieces. Specifically, bail 32′ has a left side piece (70) and a right side piece (72). The two separate side pieces (70, 72) can be raised or lowered into the up or down position independently. This two-piece construction provides greater flexibility for adjustments and accommodating different size and shape workpieces.

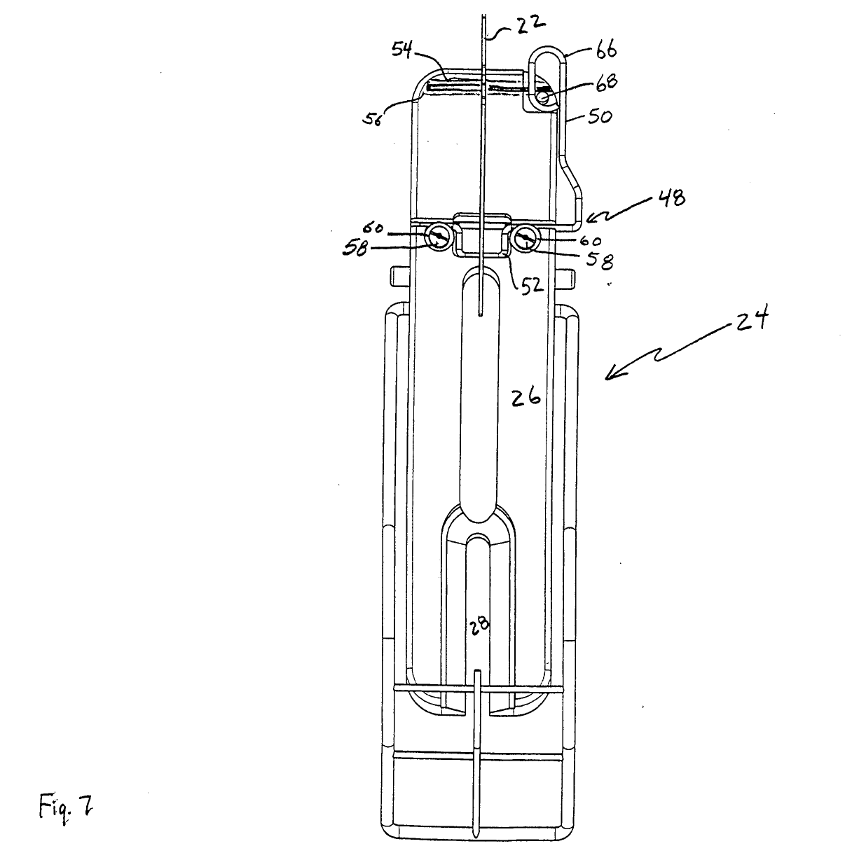

The guard (24) is mounted to the riving knife (22) through a system of pins and slots. FIG. 5 shows that in the preferred embodiment, two pins and two slots are used. The first pin is a multi-position pin (48) having a lever or arm (50) for adjusting the position of the multi-position pin (48). The multi-position pin (48) further includes a u-shaped or bent section (52) as best shown in FIGS. 5, 7 and 8. A second pin (54) is also used in the preferred embodiment. The second pin (54) is mounted to the guard top plate (26) in the preferred embodiment by press fitting the pin (54) into the bottom side of the guard top plate (26). Specifically, a channel (56) is provided at the back end (i.e., not the workpiece feed end) of the guard top plate (26), and the second pin (54) is press fit into the channel (56). Other methods for attaching the second pin (54) are also acceptable. As shown in FIGS. 5 and 7, the multi-position pin (48) is mounted to the bottom side of the guard top plate (26) through the use of two screws (58) and washers (60). Again, other methods for mounting the multi-position pin (48) are acceptable. The riving knife (22) includes slots (62, 64) for receiving the multi-position pin (50) and the second pin (54). The slots (62, 64) are dogleg shaped and are set in opposing directions as best shown in FIG. 5.

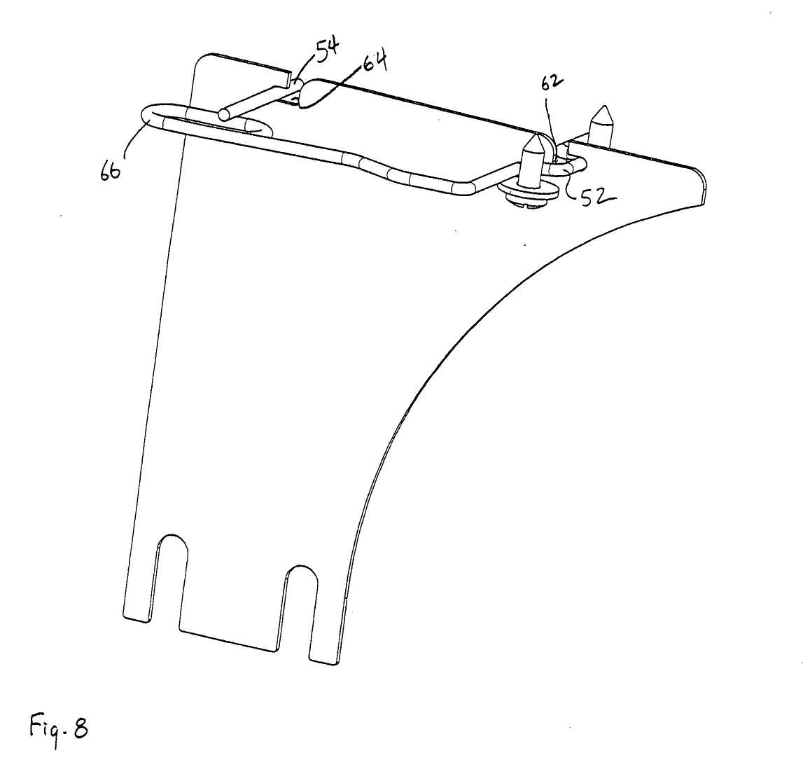

The multi-position pin (50) is capable of being moved into at least two positions. In a first or secure position, the guard (24) is securely mounted to the riving knife (22). The first position is clearly shown in FIG. 8. In the first position, the bent or u-shaped section (52) of the multi-position pin is secured in the dogleg portion of the slot (62). Likewise, the second pin (54) is also secured in the dogleg portion of the second slot (64). When in this position, pressure is exerted in the front, back, upward, and downward directions. As a result, the guard (24) is securely attached to the riving knife (22) and ready for operation. In the second or release position, the bent or u-shaped section (52) of the multi-position pin is generally located in the non-dogleg portion of the slot (62) and the pressure exerted during the first position is generally relieved. This allows the guard to be lifted, thus removing the multi-position pin (48) from slot (62) and the second pin (54) from slot (64). It is acceptable to reverse the positions of the multi-position pin (48) and the second pin (54) so that the multi-position pin (48) is located at the back end of the guard top plate (26) and the second pin (54) is located at the front end of the guard top plate (26).

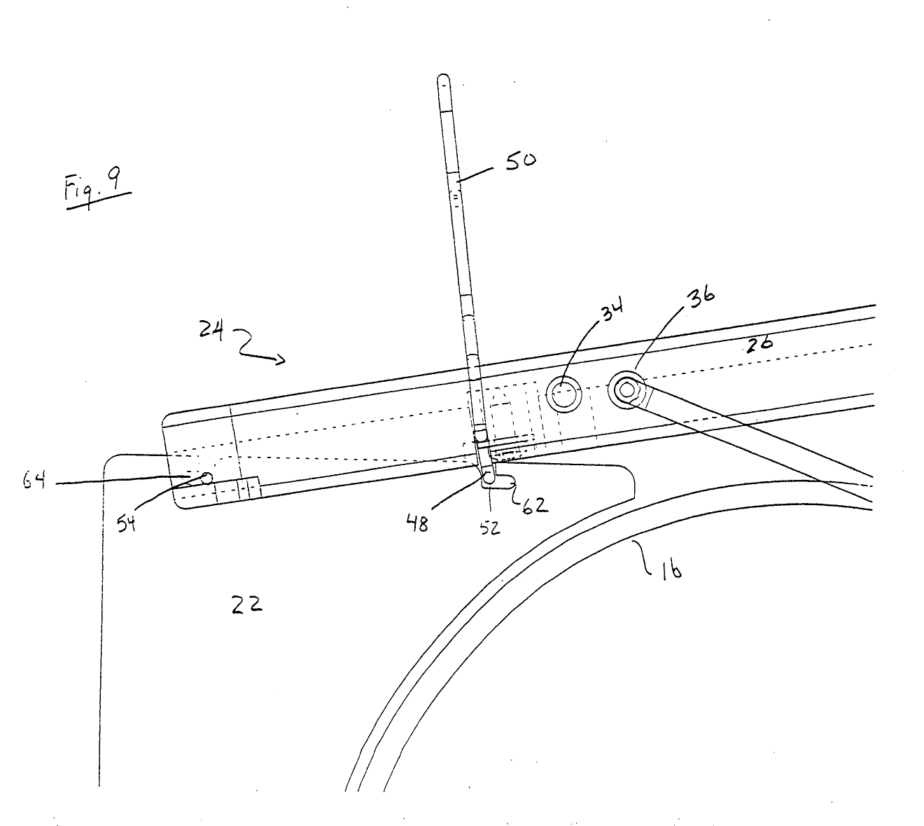

The guard (24) is capable of being attached to and removed from the riving knife (22) without the use of any tools. When attaching the guard (24) to the riving knife (22), the lever (50) initially should be in a vertical position so that it is perpendicular or near perpendicular to the guard top plate (26). When the lever (50) is in this position, the bent or u-shaped section (52) is also perpendicular or near perpendicular to the guard top plate (26) as shown in FIG. 9. The second pin (54) is placed in slot (64) and the bent or u-shaped section (52) of multi-position pin (48) is placed in slot (62). The lever (50) is engaged downwardly toward the table top (12) to move the multi-position pin (48) to the first position. As the lever (50) is engaged, the bent or u-shaped section (52) is also rotated so that it moves into the dogleg section of slot (62). As the multi-position pin (48) moves into the dogleg slot (62), the guard (24) is forced toward the backside of the table saw (10) and the second pin (54) is moved into the dogleg section of slot (64). Thus, when the multi-position pin (48) is in the first position (as best shown in FIGS. 7 and 8), the guard (24) is securely attached to the riving knife (22). Additionally, the lever (50) may be secured by tucking the handle portion (66) of the lever (50) below the guard top plate (26) as shown in FIG. 7. A securing post (68) as shown in FIGS. 5 and 7 can be used to further aid in securing the lever (50) on the under side of the guard top plate (26) while the multi-position pin (48) is in the first position. Securing the lever (50) under the guard top plate (26) as well as use of the securing post (68) helps eliminate accidental disengagement of the multi-position pin (48) to the second position.

The multi-position pin (48) must be moved to the second position (described above and shown in FIG. 9) in order to be able to remove the guard (24) from the riving knife (22). Specifically, in the preferred embodiment, the multi-position pin (48) is moved to the second position by moving the lever (50) first in a downward direction, then horizontally outward, and finally upward. This motion places the multi-position pin (48) in the second position and allows the guard (24) to be removed from the riving knife (22). Of course, other lever motions are acceptable depending on whether any additional or different securing devices are used. For example, the securing post (68) could alternatively be mounted on the side of the guard top plate (26) and the lever (50) could be structured to engage a side mounted securing post. Many other alternatives are also available.

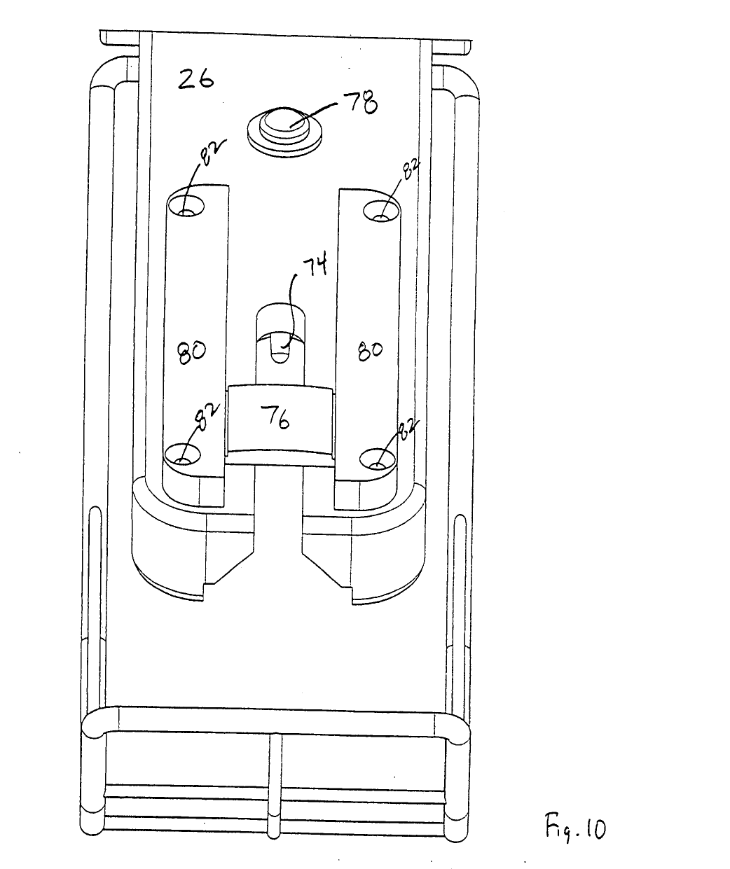

The guard (24) preferably may also include a light (74) and a magnifying lens (76) as shown in FIG. 10, although neither is required. The light (74) can be either incandescent, halogen, LED or any other acceptable light and is oriented to illuminate the cutting zone as well as the workpiece, saw blade (16) and any scale or alignment marks on the table top (12). The light (74) is mounted to the guard top plate (26) preferably in the viewing slot (28), and can be powered by wiring to the table saw (10) power source or through the use of a battery. The light (74) may be turned on and off with a switch or button (78), or may be directly wired to turn on and off in conjunction with turning on and off the saw blade (16).

The magnifying lens (76) is preferably adjustably mounted to top side of the guard top plate (26) through the use of guide rails (80) as shown in FIG. 10. The guide rails (80) in FIG. 10 are fastened to the guard top plate (26) by recessed screws (82). However, other methods for forming the guide rails (80) are acceptable such as gluing, or molding the guide rails (80) directly into the guard top plate (26). The guide rails (80) may also be located at different sections of the guard top plate (26) such as in the middle or lower portions. The guide rails (80) allow the position of the magnifying lens (76) to be adjusted by sliding the lens (76) in the guide rails (80). The magnifying lens (76) can provide an enlarged view of the cutting zone as well as the workpiece, the blade (16) and the scale or alignment marks on the table top (12). This will aid in improved set up for the cut.

The guard (24) may also be used in an active guard system. Specifically, the guard top plate (26) or the bail (32) could become part of a touch system that sets off audio or visual alarms to prevent injury. The active system could also activate a brake to stop the blade (16) or cut the power to the motor that drives the blade (16). The operation and design of an active touch system is described in pending U.S. provisional patent application No. 60/444,263 (filed on Jan. 31, 2003), which is hereby incorporated herein by reference.

Finally, the guard (24) also could have a vacuum port incorporated in the guard top plate (26). The port is attached to a vacuum source and will remove any dust or other loose matter that gathers under the guard top plate (26). This vacuum will prevent the accumulation of wood dust from cutting and will make clean up easier and quicker.

The foregoing disclosure is the best mode devised by the inventors for practicing this invention. It is apparent, however, that apparatus incorporating modifications and variations will be obvious to one skilled in the art. Inasmuch as the foregoing disclosure is intended to enable one skilled in the pertinent art to practice the instant invention, it should not be construed to be limited thereby but should be construed to include aforementioned obvious variations and be limited only by the spirit and scope of the following claims.

It is therefore intended that the foregoing detailed description be regarded as illustrative rather than limiting, and that it be understood that it is the following claims, including all equivalents, that are intended to define the spirit and scope of this invention.

1. A table saw comprising:
a frame halving a table top, said table top including a blade slot;
a saw blade extending through said blade slot;
a riving knife connected to said frame and aligned with said saw blade, said riving knife having a top and a bottom, said top having at least one slot; and
a guard releasably attached to said riving knife, said guard having a guard top plate, a multi-position pin mounted to said housing, said pin being moveable to a first position to attach securely said guard to said riving knife and moveable to a second position to allow for removal of said guard from said riving knife.

2. The table saw in claim 1 wherein said guard can be removed from said riving knife without the use of any tools.

3. The table saw in claim 1 wherein said guard further includes a second pin disposed on the lower half of said guard top plate;
said riving knife further includes a second slot; said riving knife slots being dogleg shaped slots which are in opposing directions;
said multi-position pin securely fitting in one riving knife slot and said second pin securely fitting in said other riving knife slot when said multi-position pin is in said first position; and
said multi-position pin and said second pin being removable from said slots when said multi-position pin is in said second position.

4. The table saw in claim 1 wherein said guard further includes a bail, said bail being pivotably mounted to said guard top plate so that said bail can be raised or lowered.

5. The table saw in claim 4 wherein said bail is arc-shaped.

6. The table saw in claim 1 wherein said guard further includes a viewing slot formed in said guard top plate, said viewing slot providing visible access to said saw blade, or a workpiece to be cut, or a scale on said table top.

7. The table saw in claim 1 wherein said guard further includes a magnifying lens, said lens being slidably attached to said guard top plate.

8. The table saw in claim 1 wherein said guard further includes a light source mounted to said guard top plate and oriented so that said light source illuminates one or more of said saw blade, a workpiece, or a cutting zone.

9. The table saw in claim 8 wherein said light source is mounted in a viewing slot formed in said guard top plate.

10. The table saw in claim 9 wherein said viewing slot in said guard top plate includes chamfered interior edges.

11. The table saw in claim 1 wherein said riving knife raises and lowers in unison with the saw blade.

12. A combination riving knife/guard for use with a table saw comprising:
a riving knife having at least one slot;
a guard having a guard top plate and at least one pin, said guard being releasably attachable to said riving knife by securing said pin to one of said slots;
said guard top plate having a viewing slot extending through the entire depth of said guard top plate; and
a bail pivotally attached to said guard top plate.

13. The combination riving knife/guard in claim 12 further comprising a magnifying lens slidably attached to the top portion of said guard top plate.

14. The combination riving knife/guard in claim 12 wherein said bail is a two-piece bail having a distinct left side bail portion and a distinct right side bail portion.

15. The combination riving knife/guard in claim 12 further comprising a second pin and a second slot;
said first pin being a multi-position pin;
said first and second slots receiving said multi-position pin and said second pin for securely mounting said guard to said riving knife when said multi-position pin is in a first position; and
said multi-position pin and second pin being removable from said first and second slots when said multi-position pin is in a second position.

16. The combination riving knife/guard in claim 12 wherein said guard can be attached or removed from said riving knife without using any tools.

17. A table saw comprising:
a frame having a table top, said table top including a blade slot;
a saw blade mounted to said frame and protruding above said blade slot;
a riving knife located rearward of and aligned with said blade and being fixedly adjustable with said blade height, said riving knife having at least two slots;
a guard mounted to said riving knife, said guard having a guard top plate, a first pin and a second pin, said first pin having a lever for providing a secured position for said first pin wherein said first and second pins are attached securely in said slots and a release position wherein said first and second pins are not secured in said slots and can be removed from said slots.

18. The table saw of claim 17 wherein said guard further includes a bail pivotally mounted to said guard top plate and capable of being positioned in an up or a down position, said bail extending forward from the guard top plate when in said down position.

19. The table saw of claim 17 wherein said guard further includes a light, said guard top plate has a viewing slot, and said light being oriented to illuminate said saw blade.

20. The table saw of claim 17 wherein said guard further includes a magnifying lens adjustable mounted to said guard top plate.
